(19) United States
(12) Patent Application Publication
(10) Pub. No.: US 2026/0138482 A1
(43) Pub. Date: May 21, 2026

(54) VEHICLE

(71) Applicant: TOYOTA JIDOSHA KABUSHIKI KAISHA, Toyota-shi (JP)

(72) Inventors: Yohei HOSOKAWA, Susono-shi (JP); Taku IBUKI, Susono-shi (JP)

(73) Assignee: TOYOTA JIDOSHA KABUSHIKI KAISHA, Toyota-shi (JP)

(21) Appl. No.: 19/274,985

(22) Filed: Jul. 21, 2025

(30) Foreign Application Priority Data
Nov. 18, 2024 (JP) 2024-200787

(51) Int. Cl. B60L 53/62; B60L 53/51; B60L 53/57; B60L 53/80; B60L 58/14; B60L 58/21; H02J 7/35; H02S 20/30

(52) U.S. Cl. CPC B60L 53/62; B60L 53/51; B60L 53/57; B60L 53/80; B60L 58/14; B60L 58/21; H02J 7/35; H02S 20/30

(57) ABSTRACT

The vehicle includes a plurality of secondary batteries, each of which has a low voltage, and at least some of the secondary batteries are readily attachable to and detachable from the vehicle. The secondary batteries include a secondary battery that is not removable from a charging unit that charges the secondary batteries.

### CROSS-REFERENCE TO RELATED APPLICATION

This application claims priority to Japanese Patent Application No. 2024-200787 filed on Nov. 18, 2024. The disclosure of the above-identified application, including the specification, drawings, and claims, is incorporated by reference herein in its entirety.

### BACKGROUND

### 1. Technical Field

The present disclosure relates to a vehicle.

### 2. Description of Related Art

A vehicle including a plurality of batteries including a portable battery detachably mounted on a vehicle body is known (see Japanese U.S. Pat. No. 7,482,080 (JP 7482080 B)).

### SUMMARY

In a disaster or during an activity such as leisure, the portable battery may be removed from the vehicle and used. In this case, there is a risk that the charging efficiency of the remaining batteries mounted on the vehicle is reduced or that the vehicle cannot be driven.

The present disclosure is to solve the above problem and can be implemented as follows.
(1) According to the embodiment of the present disclosure, a vehicle is provided.
   The vehicle includes a plurality of secondary batteries having a low voltage, at least some of the secondary batteries being readily attachable to and detachable from the vehicle.
   The secondary batteries include secondary batteries not removable from a charging unit charging the secondary batteries.
   With the vehicle of the aspect, even in a case where the secondary batteries have been removed from the vehicle, the at least some of the other secondary batteries remain in the vehicle. Therefore, situations in which charging becomes impossible or the vehicle cannot be driven can be suppressed.
(2) The vehicle according to the above aspect may further include:
   a determination unit configured to determine whether some of the secondary batteries are removed from the charging unit; and
   a fixing mechanism configured to fix, in a case where the determination unit determines that the some of the secondary batteries have been removed from the charging unit, at least some of other secondary batteries among the secondary batteries to the charging unit such that the at least some of the other secondary batteries are not removable from the charging unit.
   With the vehicle of the aspect, even in a case where the secondary batteries have been removed from the vehicle, the at least some of the other secondary batteries remain in the vehicle. Therefore, situations in which charging becomes impossible or the vehicle cannot be driven can be suppressed.
(3) The vehicle according to the above aspect may further include:
   a calculation unit configured to calculate a state of charge of each of the secondary batteries.
   The fixing mechanism may be configured to fix the at least some of the other secondary batteries among the secondary batteries such that the at least some of the other secondary batteries are not removable from the charging unit, the at least some of the other secondary batteries having a state of charge equal to or greater than a threshold state of charge that is predetermined.
   With the vehicle of the aspect, even in a case where the secondary batteries are removed from the vehicle, the secondary battery of which the state of charge is equal to or greater than the threshold state of charge remains in the vehicle. Therefore, a situation in which the vehicle cannot be driven can be suppressed.
(4) The vehicle according to the above aspect may further include
   a controller configured to control, in a case where the determination unit determines that the some of the secondary batteries have been removed from the charging unit, the charging unit such that a state of charge of the at least some of the other secondary batteries among the secondary batteries is able to be secured to ensure traveling performance of the vehicle.
   With the vehicle of the aspect, the state of charge that secures the traveling performance of the vehicle can be ensured. Therefore, a situation in which the vehicle cannot be driven can be suppressed.
(5) The vehicle according to the above aspect may further include:
   a calculation unit configured to calculate a state of charge of each of the secondary batteries; and
   a controller configured to control the charging unit in accordance with a predicted state of charge from a solar panel included in the charging unit and each of the state of charges
calculated by the calculation unit.
   With the vehicle of this aspect, excessive charging of the secondary battery can be suppressed.

The present disclosure can be implemented in various forms, and can be implemented, for example, in an aspect of a vehicle charging system, a fixing method of a secondary battery, a charging method of a secondary battery, or the like.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory diagram showing a configuration of a vehicle;

FIG. 2 is an explanatory diagram showing a configuration of a vehicle according to a second embodiment;

FIG. 3 is an explanatory diagram showing a configuration of a vehicle according to a third embodiment; and

FIG. 4 is an explanatory diagram showing a configuration of a vehicle according to a fourth embodiment.

### DETAILED DESCRIPTION OF EMBODIMENTS

### A. First Embodiment

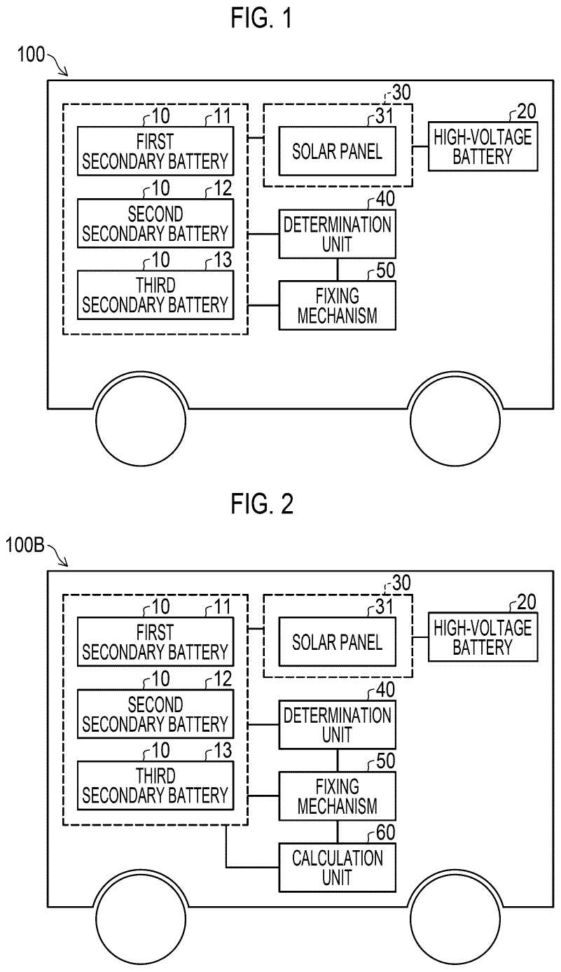

FIG. 1 is an explanatory diagram showing a configuration of a vehicle 100 according to an embodiment of the present disclosure. The vehicle 100 includes a plurality of secondary batteries 10 having a low voltage, a high-voltage battery 20 that is a secondary battery supplying electric power having a higher voltage than the secondary batteries 10, a charging unit 30, a determination unit 40, and a fixing mechanism 50. In the present embodiment, the vehicle 100 uses the electric power of the secondary battery 10 or the high-voltage battery 20 to drive a motor or an accessory (not shown) mounted on the vehicle 100.

In the present embodiment, the secondary batteries 10 include a first secondary battery 11, a second secondary battery 12, and a third secondary battery 13. All of the secondary batteries are portable batteries that can be easily attached to and detached from the vehicle 100. Hereinafter, when the secondary batteries 11, 12, 13 are referred to without distinction, the secondary batteries 11, 12, 13 are simply referred to as the secondary battery 10.

The charging unit 30 charges the secondary battery 10 or the high-voltage battery 20. In the present embodiment, the charging unit 30 includes a solar panel 31. The charging unit 30 charges the secondary battery 10 with the electric power generated by the solar panel 31 or a regenerative electric power generated by the motor.

The determination unit 40 determines whether the secondary battery 10 is removed from the charging unit 30. The determination unit 40 determines whether the secondary battery 10 is removed from the charging unit 30, for example, based on whether current can flow through the connection. In the present embodiment, the determination unit 40 can determine which of the first secondary battery 11, the second secondary battery 12, and the third secondary battery 13 is removed from the charging unit 30.

The fixing mechanism 50 fixes at least some of the other secondary batteries 10 among the secondary batteries 10 such that the charging unit 30 is not removable from the secondary batteries 10 in a case where the determination unit 40 determines that the some of the secondary batteries 10 have been removed from the charging unit 30. More specifically, the fixing mechanism 50 receives an instruction output in response to the determination unit 40 determining that a part of the secondary batteries 10 have been removed from the charging unit 30. Then, a mechanism for fixing at least some of the other secondary batteries 10 such that the at least some of the secondary batteries 10 are not removable from the charging unit 30 is driven. The fixing mechanism 50, for example, drives a latch mechanism by an actuator, and the fixing mechanism 50 and the secondary battery 10 are engaged with each other to fix the secondary battery 10 such that the secondary battery 10 is not removable from the charging unit 30.

In the present embodiment, the fixing mechanism 50 can fix each of the first secondary battery 11, the second secondary battery 12, and the third secondary battery 13 individually. The fixing mechanism 50 fixes at least one secondary battery 10 such that the at least one secondary battery 10 is connected to the charging unit 30. The fixing mechanism 50 determines a priority order in which the first secondary battery 11, the second secondary battery 12, and the third secondary battery 13 are fixed. For example, the fixing mechanism 50 fixes the second secondary battery 12 such that the second secondary battery 12 is not removable in a case where the first secondary battery 11 is removed, and does not fix the third secondary battery 13.

With the vehicle 100 of the present embodiment described above, even in a case where some the secondary batteries 10 have been removed from the vehicle 100, at least some of the other secondary batteries 10 are fixed to the vehicle 100 by the fixing mechanism 50. Therefore, situations in which the charging becomes impossible or the vehicle 100 cannot be driven can be suppressed.

### B. Second Embodiment

FIG. 2 is an explanatory diagram showing a configuration of a vehicle 100B according to a second embodiment. The vehicle 100B according to the second embodiment is different from the first embodiment in that the vehicle 100B includes a calculation unit 60, and the other configurations are the same.

The calculation unit 60 calculates the state of charge of each of the secondary batteries 10. In the present embodiment, the calculation unit 60 integrates a current value and time of charging and discharging in each secondary battery 10, for example, to obtain the state of charge. The disclosure is not limited thereto, and the calculation unit 60 may obtain the state of charge of each secondary battery 10 based on a map or a function in which the relationship between the voltage value and the state of charge of the secondary battery 10 is defined.

In the present embodiment, the fixing mechanism 50 fixes at least one of the secondary batteries 10 of which the state of charge calculated by the calculation unit 60 is equal to or greater than a threshold state of charge that is predetermined such that the at least one secondary battery 10 is not removable from the charging unit 30. The threshold state of charge is a value being optionally determined and may be determined by the user. In addition, the threshold state of charge may be determined depending on a distance to a destination or a distance of a power feed section in which a non-contact power feed device is installed and wireless power feed can be performed during traveling on a traveling route to the destination.

With the vehicle 100 of the embodiment described above, the secondary battery 10 of which the state of charge is equal to or greater than the threshold state of charge remains in the vehicle 100. Therefore, a situation in which the vehicle 100 cannot be driven can be suppressed.

### C. Third Embodiment

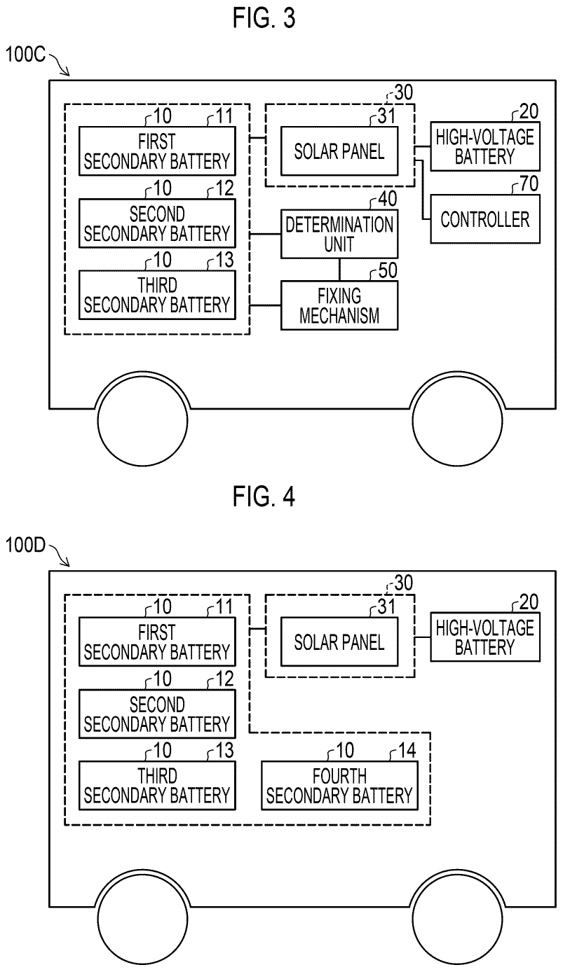

FIG. 3 is an explanatory diagram showing a configuration of a vehicle 100C of a third embodiment. The vehicle 100C according to the third embodiment is different from the first embodiment in that the vehicle 100C includes a controller 70, and the other configurations are the same.

The controller 70 is a computer including a central processing unit (CPU), a RAM, and a ROM, and the CPU executes a program installed in a storage area of the controller 70, such as the RAM or the ROM, in advance to control the charging unit 30. Note that a part or all of the function may be implemented by a hardware circuit.

In the present embodiment, in the controller 70, the determination unit 40 may determine that some of the secondary batteries 10 are removed from the charging unit 30. In this case, the controller 70 controls the charging unit 30 such that the state of charge of the at least some of the other secondary batteries 10 among the secondary batteries 10 is able to be secured to ensure the traveling performance of the vehicle 100.

With the vehicle 100 of the present embodiment described above, the state of charge that secures the traveling performance of the vehicle 100 can be ensured. Therefore, a situation in which the vehicle 100 cannot be driven can be suppressed.

### D. Fourth Embodiment

FIG. 4 is an explanatory diagram showing a configuration of a vehicle 100D of a fourth embodiment. The vehicle 100D according to the fourth embodiment includes the fourth secondary battery 14, and is different from the first embodiment in that the determination unit 40 and the fixing mechanism 50 are not provided, and the other configurations are the same.

The fourth secondary battery 14 is a secondary battery 10 having a low voltage that is completely fixed to the vehicle 100, unlike the other secondary batteries 11, 12, 13. The fourth secondary battery 14 is not easily removable from the vehicle 100 in principle, except while the fourth secondary battery 14 is being repaired or replaced. The fourth secondary battery 14 is welded to the vehicle 100 by, for example, nut welding.

With the vehicle 100D of the aspect, even in a case where the first secondary battery 11, the second secondary battery 12, and the third secondary battery 13 are removed from the vehicle 100, the fourth secondary battery 14 remains in the vehicle 100. Therefore, situations in which the charging becomes impossible or the vehicle 100D cannot be driven can be suppressed.

### E. Other Embodiments

(E1) In the above-described embodiment, the vehicle 100 includes three secondary batteries 10. The present disclosure is not limited thereto, and the vehicle 100 may include two, or 4 or more secondary batteries 10.
(E2) In the above-described embodiment, the vehicle 100 includes the high-voltage battery 20. The vehicle 100 is not limited thereto, and may not include the high-voltage battery 20. In this case, some of the secondary batteries 10 supply electric power at a higher voltage than other secondary batteries 10.
(E3) In the above-described embodiment, the charging unit 30 has the solar panel 31. The present disclosure is not limited thereto, and the charging unit 30 need not include the solar panel 31.
(E4) In the above-described embodiment, the charging unit 30 may be configured to perform the rapid charging of the secondary battery 10. The charging unit 30 may perform the rapid charging, for example, in response to an instruction from the user.
(E5) In the above-described embodiment, the fixing mechanism 50 receives the instruction output in response to the determination of the determination unit 40 that some of the secondary batteries 10 have been removed from the charging unit 30. Then, a mechanism for fixing the secondary battery 10 such that the secondary battery 10 is not removable from the charging unit 30 is driven. The present disclosure is not limited thereto, and the fixing mechanism 50 may have a structure in which the secondary battery 10 is fixed such that the secondary battery 10 is not removable from the charging unit 30, in response to the removal of some of the secondary batteries 10 from the charging unit 30. For example, the fixing mechanism 50 may have a structure in which the secondary battery 10 is fixed such that the secondary battery 10 is not removable from the charging unit 30, in response to reduction of the weight of the secondary battery 10 fixed to the charging unit 30 to a weight equal to or less than a threshold weight that is predetermined.
(E6) In the first embodiment, the second embodiment, and the third embodiment described above, the fixing mechanism 50 fixes at least one secondary battery 10 such that the secondary battery 10 is connected to the charging unit 30. That is, even in a case where the two secondary batteries 10 are connected to the charging unit 30, solely one of the secondary batteries 10 is fixed such that the one secondary battery 10 is not removable from the charging unit 30. The present disclosure is not limited thereto, and the fixing mechanism 50 may be configured to fix all the other secondary batteries 10 such that the all the other secondary batteries 10 is not removable from the charging unit 30 in a case where the determination unit 40 determines that one secondary battery 10 has been removed.
(E7) In the third embodiment described above, the controller 70 may perform maximum power point tracking (MPPT) control. In this case, the vehicle 100C preferably includes the calculation unit 60. More specifically, the controller 70 may control the charging unit 30 such that the state of charge of the secondary battery 10 becomes a target state of charge that is predetermined, according to a predicted state of charge from the solar panel 31 and the state of charge of the secondary battery 10 calculated by the calculation unit 60. The state of charge from the solar panel 31 is predicted using, for example, weather information, an outdoor traveling distance on a traveling route to a destination, or the like. With this aspect, the overcharging of the secondary battery 10 can be suppressed. In addition, in a case where the user uses the secondary battery 10 removed from the charging unit 30, a situation in which the state of charge of the removed secondary battery 10 is insufficient can be suppressed.
(E8) In the third embodiment described above, the power may not be supplied from the high-voltage battery 20 to the controller 70. In this case, the controller 70 may control the charging unit 30 such that the state of charge of the secondary battery 10 becomes an adjustment state of charge that is predetermined, without supplying the electric power from the high-voltage battery 20 and without supplying the electric power to the high-voltage battery 20. In a case where the power is not supplied from the high-voltage battery 20, when the power is supplied from the high-voltage battery 20 to an auxiliary device to adjust the state of charge of the secondary battery 10, the power consumption of the auxiliary device increases, and the charging efficiency may decrease. Therefore, according to the present embodiment, the state of charge of the charging unit 30 can be adjusted without reducing the efficiency of charging.

The present disclosure is not limited to the above-described embodiments, and can be implemented with various configurations without departing from the gist of the present disclosure. For example, the technical features in the embodiments corresponding to the technical features in the respective forms described in SUMMARY can be replaced or combined as appropriate to solve the above-described objects, or to achieve a part or all of the above-described effects. In addition, in a case where the technical features are not described as being always needed in the present specification, the features can be deleted as appropriate.

What is claimed is:

1. A vehicle comprising:
a plurality of secondary batteries having a low voltage, at least some of the secondary batteries being readily attachable to and detachable from the vehicle,
wherein the secondary batteries include a secondary battery not being removable from a charging unit charging the secondary batteries.

2. The vehicle according to claim 1, further comprising:
a determination unit configured to determine whether some of the secondary batteries are removed from the charging unit; and
a fixing mechanism configured to fix, in a case where the determination unit determines that the some of the secondary batteries have been removed from the charging unit, at least some of other secondary batteries among the secondary batteries to the charging unit such that the at least some of the other secondary batteries are not removable from the charging unit.

3. The vehicle according to claim 2, further comprising:
a calculation unit configured to calculate a state of charge of each of the secondary batteries,
wherein the fixing mechanism is configured to fix the at least some of the other secondary batteries among the secondary batteries such that the at least some of the other secondary batteries are not removable from the charging unit, the at least some of the other secondary batteries having a state of charge equal to or greater than a threshold state of charge that is predetermined.

4. The vehicle according to claim 2, further comprising:
a controller configured to control, in a case where the determination unit determines that the some of the secondary batteries have been removed from the charging unit, the charging unit such that a state of charge of the at least some of the other secondary batteries among the secondary batteries is able to be secured to ensure traveling performance of the vehicle.

5. The vehicle according to claim 1, further comprising:
a calculation unit configured to calculate a state of charge of each of the secondary batteries; and
a controller configured to control the charging unit in accordance with a predicted state of charge from a solar panel included in the charging unit and each of the state of charges calculated by the calculation unit.
